(19) United States
(12) Patent Application Publication
(10) Pub. No.: US 2026/0278250 A1
(43) Pub. Date: Sep. 17, 2026

(54) REAL-TIME MULTI-LANGUAGE TRANSCRIPTION WITH COLLABORATIVE EDITING

(71) Applicant: TRINT LIMITED, London (GB)

(72) Inventors: Alessandro DELFINO, London (GB); Olga KUDRYAVTSEVA; Jinn KORIECH, London (GB); John ST. LEGER, London (GB); Anna BLAZIAK, London (GB); Anthony BILLON, London (GB); Jonathan BEAUMONT, London (GB); Annie DUTREMBLE, London (GB); Jamie MORRISON, London (GB); Peter SLIGHT, London (GB); Jeffrey KOFMAN, London (GB)

(21) Appl. No.: 19/471,248

(22) PCT Filed: Apr. 3, 2024
(86) PCT No.: PCT/GB2024/050907

§ 371 Date: Sep. 30, 2025

Related U.S. Application Data
(60) Provisional application No. 63/456,693, filed on Apr. 3, 2023.

(51) Int. Cl. G06F 40/166; G06F 40/284; G06F 40/58; G10L 17/06; G10L 25/78

(52) U.S. Cl. CPC G06F 40/166; G06F 40/284; G06F 40/58; G10L 17/06; G10L 25/78

(57) ABSTRACT

A computer implemented method of and system for processing multi-language audio data that includes a first audio segment that corresponds to a first language and a second audio segment that that corresponds to a second language. First transcript data is automatically generated for the first audio segment, including text representations of a first group of one or more spoken words, and timecode data. Second transcript data is automatically generated for the second audio segment, including text representations of a second group of one or more spoken words, and timecode data. The first transcript data and the second transcript data are combined into a transcript document that can be accessed together with the multi-language audio data at a client device.

### RELATED APPLICATIONS

This application claims the benefit of and priority to U.S. Provisional Patent Application No. 63/456,693 filed Apr. 3, 2023, the contents of which are incorporated herein by reference.

### FIELD

This disclosure relates generally to automated systems and methods for real-time multi-language transcription and distribution with collaborative editing.

### BACKGROUND

Quick dissemination of accurate and trustworthy information over media distributions systems that rely on networks such as the Internet has become critical. Cloud-based solutions can enable multiple people to collaborate remotely to provide such information. For example, a first person can capture a live audio or video of an event in real-time using a media capture device such a smartphone. The audio or video can be uploaded as a media stream to a cloud-based service that enables review and editing by multiple authorized users for inclusion in media content that can be streamed to or downloaded by end users.

Automated Speech-to-Text transcription can be provided to add accompanying text content to the audio or video media content. In many scenarios, multiple languages may be captured in a live audio or video feed. Providing automated speech-to-text transcription for audio that includes multiple languages in a collaborative environment is beyond the abilities of commonly available solutions.

For example, modern newsrooms need to be able to collaborate remotely on events taking place across the world in real-time, including those in which multiple languages are being spoken. Real-time transcription services are a fundamental tool for such newsrooms, but current solution providers do not offer viable real-time transcription and translation in multiple languages with collaborative editing.

Accordingly, there is a need for systems and methods that can effectively enable real-time multi-language transcription and distribution with collaborative editing.

### SUMMARY

According to an example aspect, a computer implemented method and system is described that can enable real-time multi-language transcription and distribution with translations and collaborative editing.

According to one example aspect a computer implemented method is disclosed for processing multi-language audio data that includes a first audio segment that corresponds to a first language and a second audio segment that that corresponds to a second language. First transcript data is automatically generated for the first audio segment, including text representations of a first group of one or more spoken words, and timecode data. Second transcript data is automatically generated for the second audio segment, including text representations of a second group of one or more spoken words, and timecode data. The first transcript data and the second transcript data are combined into a transcript document that can be accessed together with the multi-language audio data at a client device.

### BRIEF DESCRIPTION OF THE DRAWINGS

Reference will now be made, by way of example, to the accompanying drawings which show example embodiments of the present application, and in which:

FIG. 1 is a block diagram illustrating a system that can be used to implement real-time multi-language transcription with collaborative editing according to example implementations.

FIG. 2 illustrates a display screen of a web page interface generated by online collaborative editor as presented on a browser interface display of a client device.

FIG. 3 is a block diagram illustrating functional modules and information flow of a multi-language generator module of the system of FIG. 1, according to an example implementation.

FIG. 4 is a block diagram illustrating a speech-to-text transcription module of a language detection and transcription module of the multi-language generator module of FIG. 3, according to an example implementation.

FIG. 5 shows an example of a plot representing an aggregated two-dimensional cross-attention matrix.

FIG. 6A illustrates a snippet of a multi-language transcript illustrating an example use scenario according to example embodiments.

FIG. 6B illustrates a snippet of a translated version of the multi-language transcript of FIG. 6A.

FIGS. 7A, 7B and 7C illustrates a set of successive display screens of a web page interface generated by an online collaborative editor of the system of FIG. 1 as presented on a browser interface display of a client device, according to example implementations.

FIG. 8A illustrates a display screen of a web page interface generated by the online collaborative editor, according to example implementations.

FIG. 8B illustrates the snippet of the FIG. 6A illustrating an example use scenario according to example embodiments.

FIG. 8C illustrates an updated version of the snippet of the FIG. 8B.

FIG. 8D illustrates a display screen of a web page interface generated by the online collaborative editor in respect of the snippet of FIG. 8C.

FIG. 9A illustrates a further snippet illustrating an example use scenario according to example embodiments.

FIG. 9B illustrates a display screen of a web page interface generated by the online collaborative editor corresponding to the snippet of FIG. 9A.

FIG. 9C illustrates an updated version of the snippet of the FIG. 9A.

FIG. 9D illustrates a display screen of a web page interface generated by the online collaborative editor in respect of the snippet of FIG. 9C.

FIG. 10 illustrates a further block diagram representation of aspects of the system of FIG. 1.

FIG. 11 shows a further representation of functional components of a multi-language transcript generator module according to example implementations.

FIG. 12 shows an example of a clipped word.

FIG. 13 shows an example of a repeated word.

FIG. 14 illustrates a further display screen of a web page interface generated by online collaborative editor as presented on a browser interface display of a client device.

FIG. 15 illustrates an example of a computer system that can be used to implement modules or devices of the system of FIG. 1.

Similar reference numerals may have been used in different figures to denote similar components.

### DESCRIPTION OF EXAMPLE EMBODIMENTS

Computer implemented methods and systems are disclosed that support real-time multi-language transcription and distribution with collaborative editing. According to an example implementation, systems and methods are disclosed for implementing a real-time multi-language transcription with collaborative editing service that receives, from a local user device, live audio of an event that in which multiple languages are being spoken and performs live transcription of the multi-language audio, with the different languages being automatically identified and transcribed into a single document. The service further provides the ability for other remote user devices to display and edit the transcript and original media concurrently in real-time, and translate the transcript into other arbitrary languages.

By way of context, an illustrative example of a use case to which the solutions presented in this disclosure can be applied is as follows: A journalist wants to record and transcribe an event in which multiple languages will be spoken, to view the transcript themselves, and be able to share it with colleagues at the news desk along with the original media. It is not necessarily known which languages will be spoken before the event starts. An example of such an event is a session of the European Parliament. The use case requires: the audio for the event be recorded; a transcription of the audio be sent to the news desk as a along with the original audio/video as quickly as possible to facilitate publishing fast, accurate content; and the transcript to be translated into one or more other languages so that a journalist can understand what was said even if they cannot speak one or more of the languages that was being spoken.

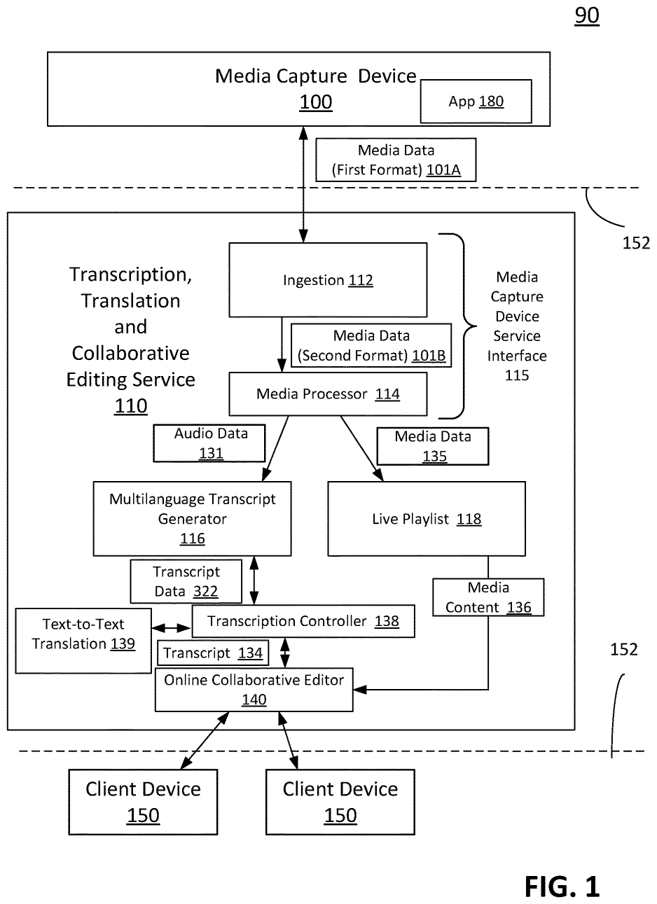

In this regard, FIG. 1 depicts an example embodiment of a real-time multi-language transcription with collaborative editing system 90 (hereafter “system 90”) according to an example implementation. System 90 includes a media capture device 100, a transcription, translation and collaborative editing service 110 (hereinafter “service 110”), and one or more remote client devices 150. In some examples, service 110 can be a cloud-based service that is accessible by media capture device 100 and remote client devices 150 through an application programming interface (API).

In some examples, service 110 may be offered as a commercial service to subscribers. In alternative examples, service 110 can be an in-house secure service that is accessible only by authorized users.

Media capture device 100 and remote client devices 150 can communicate with service 110 through a communication network 152. Media capture device 100 and remote client devices 150 can, for example, each be a respective processor-based wireless network-enabled computing device such as a smartphone, a laptop computer, or a tablet, among other devices. In some examples, media capture device 100 and/or can remote client devices 150 can alternatively be a device such as a stationary desktop computer that has a wired network connection.

In the illustrated example, media capture device 100 and remote client devices 150 are each configured to maintain connectivity with communication network 152, which can for example include the Internet as well as intervening wireless and/or wired networks. By way of example, communication network 152 can include any wireless network capable of enabling a plurality of communication devices to wirelessly exchange data such as, for example, a wireless Wide Area Network (WAN) such as a cellular network (e.g., an LTE, 4G, 5G, or 6G network), a wireless local area network (WLAN) 104 such as Wi-Fi™, or a wireless personal area network (WPAN) (not shown), such as Bluetooth™ based WPAN. Communication network 152 can include a network gateway that connects intermediate networks to the Internet. Communication network 152 can include wired networks such as Ethernet and/or fibre networks.

Service 110, which as indicated above can, by way of non-limiting example, be a cloud-based service that is accessible through the Internet, is configured to receive and process media content that is streamed or provided as files from one or more media capture devices 100. Service 110 may for example be implemented by one or more one or more servers that are configured by software to provide the functionality described herein. The servers may be located at a central physical location or distributed across multiple locations. In example embodiments, service 110 auto-generates a text transcript of spoken words that are included as an audio component of the media content stream. The text transcript includes timing metadata to enable the text transcript to be displayed in time synchronization with audio playback of the audio component. Service 110 enables multiple users to access a playback and text editing tool through respective client devices 150 to collaboratively correct the auto-generated text transcript. Client devices 150 can, for example, include processor enabled computing devices such as laptop-computers, desktop computers, smart phones, tablets and the like that can interface with transcription system 110 via communication network 152 to enable user review of media content and collaborative text editing of an associated text transcript.

Non-limiting examples of transcription and editing systems than can be used to implement one or more components of transcription system 110 are disclosed in US. U.S. Pat. No. 10,546,588, “MEDIA GENERATING AND EDITING SYSTEM” and US. U.S. Pat. No. 11,301,644, “GENERATING AND EDITING MEDIA”, both issued to Trint Limited, the contents of which are incorporated herein by reference.

Media capture device 100, service 110, and client devices 150 can each be provisioned with software to enable them to implement modules for performing various functions described herein. As used here, a “module” can refer to a combination of a hardware processing circuit and machine-readable instructions and data (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

In some examples, one or more modules can be implemented using suitably configured processor enabled computer devices or systems such as personal computers, industrial computers, laptop computers, computer servers and programmable logic controllers. In some examples, individual modules may be implemented using a dedicated processor enabled computer device, in some examples multiple modules may be implemented using a common processor enabled computer device, and in some examples the functions of individual modules may be distributed among multiple processor enabled computer devices.

In the illustrated example, media capture device 100 includes one or more modules that configure the media capture device to capture real-time audio data through a microphone of the media capture device 100 and video through a video camera of the media capture device 100 to generate media content in the form of a media data stream of audio and video data. In some examples, the media capture device 100 is enabled to capture audio data without also capturing video data, such that the generated media stream is an audio-only stream.

Media capture device 100 also includes one or more modules that formats the media data stream into a format suitable for transmission through the communication network 152, and one or more modules that manages transmission of the formatted media stream to the service 110 via the communication network 152.

In example embodiments, transcription, translation and collaboration editing service 110 can include modules such as those shown in FIG. 1. The modules can, for example, include a media capture device service interface module 115 for interfacing with the media capture device 110 during a live media session. Service interface module 115 can for example include a data ingesting module 112 for ingesting a media data stream (media data 101A) transmitted by a media capture device 100. Data ingestion module 112 can, for example, be configured to receive media data 101A in a first format that is suitable for communications over network 152 and then place that information into second format (media data 101B) that is suitable for use by processing by service 110. Service interface module 115 can also include a media processor module 114. Media processor module 114 processes the ingested media data stream (media data 101B) and feeds corresponding output data (e.g., audio data 131 and media data 135 that are required to provide time-aligned text data (e.g., transcript 134) and media content 136 to a downstream online collaborative editor module 140 (described below). By way of example, audio data 131 could be segments of acoustic signals extracted from the media data (which could for example be audio-visual data in the case where the media data 101B is video). Media data 135 can be segments of the original media (e.g., video that include both audio and visual data) that are synchronized with audio data 131.

As explained in greater detail below, multi-language transcript generator 116 is configured to receive the audio data 131 provided by the media processor module 114, recognize the language used in the audio data 131, and generate corresponding text transcript data 322 that can include detected language transcribed data (including text elements and time-code (e.g., time stamp) elements), speaker data, and other language transcript data.

Transcription controller 138 functions as a service interface between the online collaborative editor 140 and multi-language transcript generator module 116. Transcription controller 138 can, for example, assemble transcript data 322 received from multi-language transcript generator module 116. Text transcript segments and other data included in text transcript data 322 are appended together as they are generated to provide a time-stamped transcript 134 for media content 136 that is represented by the sequence of media data segments 134. The time-code data included with the transcript 134 provides a time-alignment between the text words in the transcript 134 and the media content 136. The time-coded transcript 134 can be provided in real-time or close to real-time to online collaborative editor 140. In real-time applications, the transcript 134 will be continually updated as new incoming media content is processed.

In some examples, a live playlist module 118 can be provided that is configured to append segments of media data 135 from the Media Processor module 114 to a playlist that defines media content 136 that corresponds to the original continuous media data 101A (e.g., audio data and when included, video data) that was captured by the media capture device 100. For example, the live playlist module 118 can apply a protocol to generate a continuous stream of media content 136 from the data segments. This content can, for example, be stored as one or more media content files in a persistent file storage that is accessible to online collaborated editor module 140. In some examples, live playlist module 118 may be omitted and the media content 136 may conform directly to media data 101B without any intermediate processing steps.

Online Collaborative Editor 140 comprises one or more modules that allows multiple users using respective client devices 150 to view and edit the same piece of content collaboratively, including, for example during a live recording session as source data is being captured by media capture device 100. The content includes media content 136 with a time-aligned transcript 134. In at least some examples, online collaborative editor 140 allows collaborators to view and edit the content of a document that corresponds to transcript 134 as it is being produced, with each collaborator able to independently interact with any part of the document without impacting other collaborators or the in-progress real-time transcription. In some examples, online collaborative editor 140 allows collaborators to view and edit the content of a document that corresponds to transcript 134 of a pre-recorded media session, with each collaborator able to independently interact with any part of the document.

The combined operation of the media capture device 100 and service 110 can enable real-time or close to real-time (subject to transmission and processing lags) viewing of media content, together with time-aligned transcription text at the client devices 150 as the media content is being captured by the media capture device 100.

Aspects of the service 110 that are specifically configured to support multiple-language transcriptions will now be described.

In order to help people to work with languages that they cannot speak, service 110 includes the ability to translate the transcript into another language in real-time. Multi-language transcript generator 116 enables the translation of transcribed text form an original language into other language(s), both in real-time if pre-configured or on demand as the user interacts with the document requests. The online collaborative editor 140 provides an interface through which multiple users can interact with a document and may, in various implementations, support: (i) presentation of the original and translated transcript in a common context; (ii) UI elements that highlight the translated word(s) as they are being spoken whilst the media is being played in the original language; (iii) UI elements that provide visual indicators for what language is being spoken; and/or (iv) Ability to re-transcribe the original media of a given section or time segment into another language by selecting the range and submitting for processing.

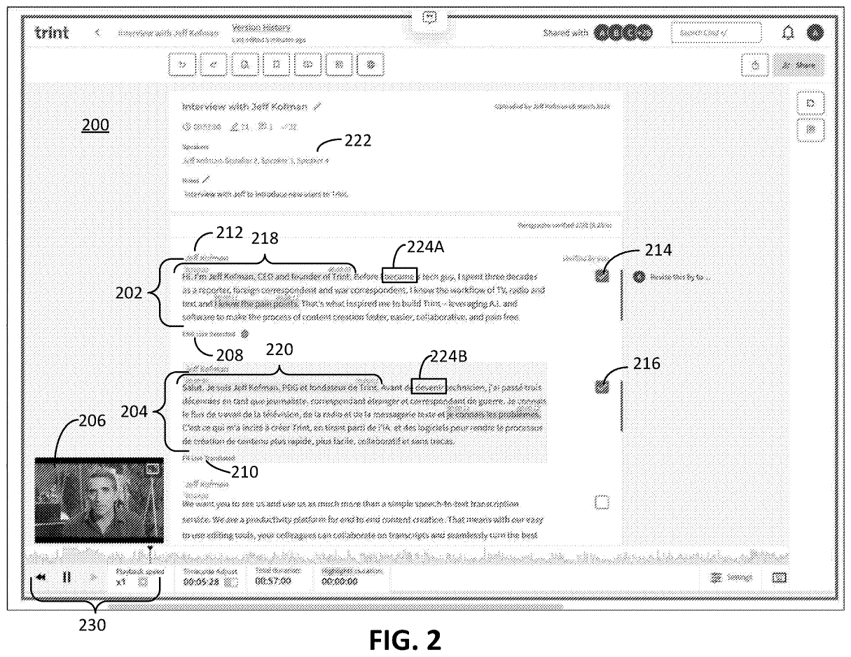

By way of context, FIG. 2 illustrates a user interface display screen 200 of a web page interface generated by online collaborative editor 140 as presented on a browser interface display of a client device 150, according to an example implementation. A multi-language text transcript, generated by automated speech recognition module 132, of media containing multiple languages, is shown. Functionality of online collaborative editor 140 will be discussed in greater detail below.

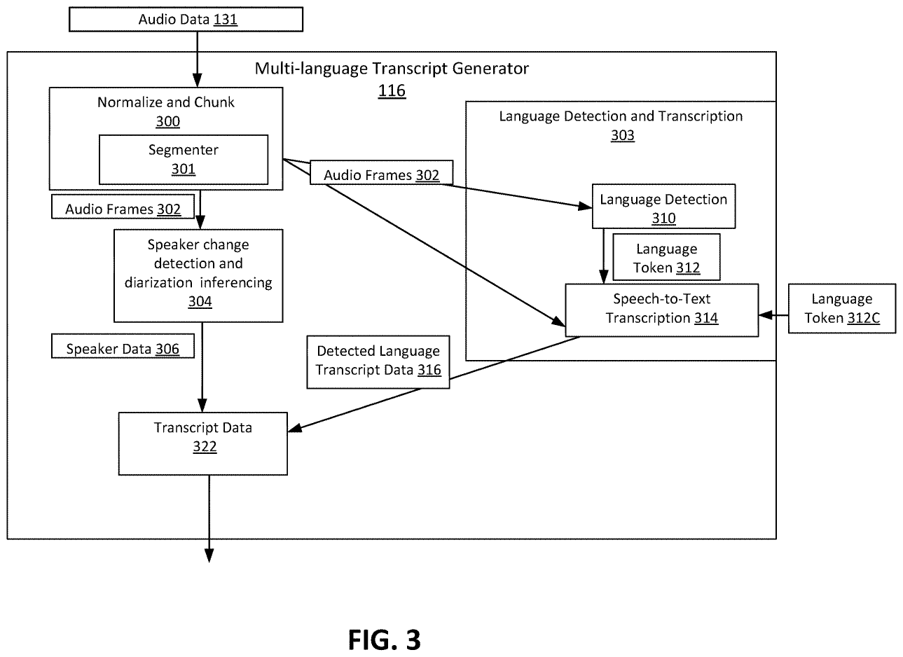

Multi-language transcript generator 116 will now be explained in greater detail with reference to FIG. 3. Multi-language transcript generator 116 includes a set of sub-modules (also referred to as operations) that provide backend services including language detection, transcription, speaker detection, and diarization of incoming media that contains multiple languages. Following transcription, a multi-language capable document (e.g., transcript 134) is generated that includes embedded schema (e.g., timecodes, speaker identification, and language attributes, among other things).

In the illustrated example of FIG. 3, multi-language transcript generator 116 includes a normalize and chunk module 300 that is configured to receive audio data 131 as input and normalize and chunk that data into one or more audio frames 302 (which may, for example conform to the WAVE (.WAV) encoding format). In this regard, normalize and chunk operation 300 can include a segmenter module 301 that implements a segmenting operation to split the audio data 131 into audio frames 302 that each correspond to a segment of continuous voice activity by a single speaker in a single language. In this regard, audio frames 302 can have varying lengths as each frame corresponds to a duration in which the acoustic signal represented in audio data 131 is continuous without a pause in voice activity being detected. For example, a pause may be detected when the acoustic signal amplitude drops below a defined threshold activity criteria. Accordingly, in the example of FIG. 1, normalize and chunk operation 300 functions to detect discrete segments of continuous voice activity within the audio data that corresponds to a single speaker using a single language. In example implementations, segmenter module 301 may include a DNN model such as a transformer-based encoder-decoder model that is pre-trained to receive a sequence of audio data and segment that audio date into discrete, language specific audio frames 302 each audio frame has associated audio frame timecode data that indicates the location (e.g., in the form of a time index value or an actual time) of the audio frame 302 within a duration of the audio date 131/media data 135).

Each audio frame 302 is then provided, in sequence to a language detection and transcription module 303 for processing.

In the illustrated example, language detection and transcription module 303 includes a language detection module 310 that is configured to receive an audio frame 302 as input, detect a language for that audio frame 302, and then output a respective language token 312 for the audio frame. In example embodiments, the language detection module 310 is implemented using a deep neural network (DNN) model in the form of a transformer-based encoder-decoder model that has been pretrained to classify an input audio segment as belonging to one of a plurality of candidate languages. The candidate languages are the languages that are supported by multi-language transcript generator 116. By way of non-limiting example, the OpenAI™ Whisper model from Hugging Face, Inc. can be used to implement the encoder-decoder model of language detection module 310.

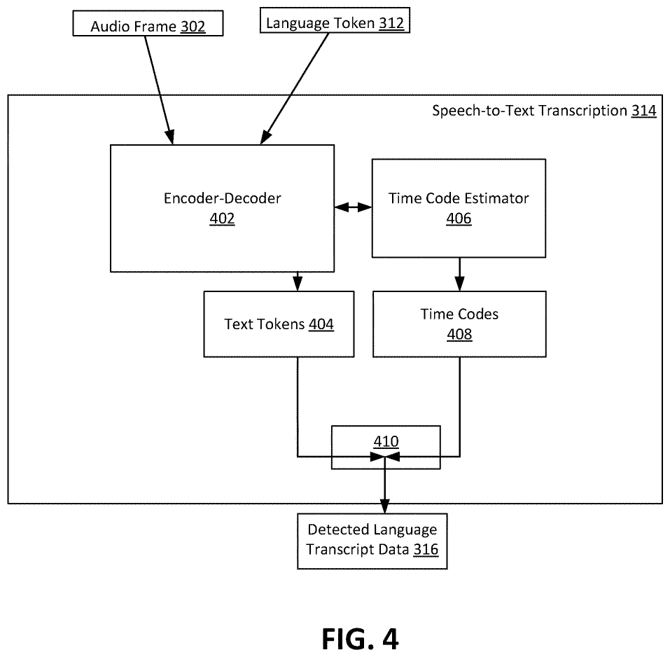

The language token 312 that identifies the detected language, together with is corresponding audio frame 302, are provided as inputs to speech-to-text (S2T) transcription module 314, which outputs corresponding detected language transcript data 316. In some examples, a default language token is assumed if no language token is received. FIG. 4 shows a S2T transcription module 314 according to an example embodiment. In some examples, S2T transcription module 314 includes a DNN model in the form of an attention based audio-sequence-to-text-sequence model, for example a transformer based encoder-decoder model 402 that has been trained to receive the audio frame 302 and language token 312 as inputs and generate a corresponding sequence of text tokens that represent the sequence of spoken words that are present in the audio frame 302. In some examples, each discrete word may be represented by one or more text tokens. By way of non-limiting example, the above-noted OpenAI™ Whisper model from Hugging Face, Inc. can also be used to implement encoder-decoder model 402.

In example embodiments, S2T transcription module 314 is configured to associate each text token that is generated with time code data (e.g., a starting time stamp and/or an ending time stamp) that maps the text token back to the location of the spoken word that it represents in the audio data 131/media data 135. To accomplish this, in at least some implementations, S2T transcription module 314 includes a time-code estimator operation 406 that collaborates with a cross-attention mechanism of the encoder-decoder model 402 to estimate time code data for each respective text token. Cross-attention mechanism introduces information (e.g., cross attention vector embeddings) from the input sequence to layers of the decoder to enable the decoder to predict the next output sequence token.

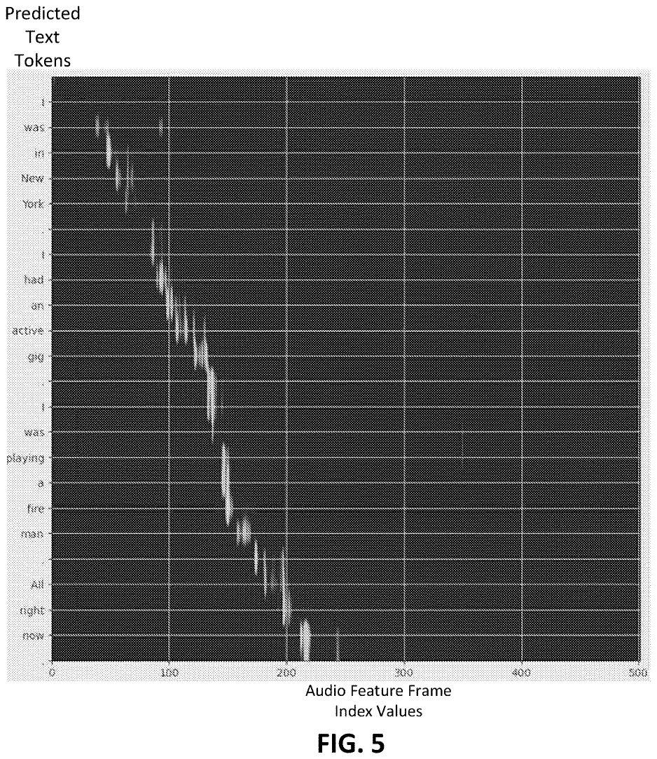

FIG. 5 graphically illustrates, for context, an example of a plot representing a two dimensional cross-attention matrix (vector embeddings represented as bright areas on the plot) generated in respect of predicted text tokens (y-Axis) over the duration (x-axis, frame index) of an audio frame 302, Each feature frame index corresponds to a sampled audio feature frame extracted from the audio frame 302. For example, each audio feature frame could correspond to 20 ms of audio. The brightness/size of each of the vector embeddings indicates a degree to which the audio information that located at a particular frame index contributed to the respective text token. The 2-D matrix represented in FIG. 5 will have as many rows as decoded tokens and as many columns as feature frames.

An example of a process performed by time-code estimator operation 406 to obtain time code data is as follows:
1. Receive the text tokens 404 generated as encoder-decoder model 402 outputs in respect of an input audio frame 302.
2. Receive cross attention vector embeddings generated by the attention mechanism of the encoder-decoder model 402.

3. Aggregate the cross-attention vector embeddings to obtain a 2-D matrix (e.g., graphically represented in FIG. 5). One possible way to aggregate the cross-attention vector embeddings is to add them together.

4. For each predicted token, identify the input feature frame that contributes the most to the production of said token. Each feature frame is produced at a fixed interval (e.g., 20 ms in the present example, but this value may vary) so identifying the feature frame that contributes the most to the production of a token effectively identifies the point in time that marks the beginning of that token. In some examples, one possible way to identify the input feature frame that contributes the most to the production of a predicted token (e.g., the i-th token): (a) Find a maximum value (e.g., the argmax) of the i-th row of the aggregated cross-attention matrix; (b) convert the feature frame index that corresponds to the maximum value to a time value (e.g., seconds) and save that converted value as the beginning of the current text token and the end of the previous text token (If the current token is not the first text token); if the current it the last token of the audio frame, set the end of the token time to the end of the audio frame.

As indicated at block 410, timecodes 408 are then assigned to words that are represented by the text tokens 404, resulting in detected language transcript data 316 that includes words with their timecodes. In some examples, words may be split into multiple text tokens; in such examples, block 410 can be configured to detect and combine the text tokens that form words parts. In the case where multiple text tokens are combined to form a word, the beginning time timecode for the first text token is used as the starting time code for the word and the ending timecode of last token that composes the word is used as the ending timecode for the word.

With reference to FIG. 3, in example embodiments the audio frames 302 are also provided to a speaker detection and diarization inferencing module 304 that is configured to detect and identify different speakers in the audio files, and diarize speaker timecode data that indicates when there is a change in speakers. The output of module 304 can be diarized speaker data 306 that identifies unique speakers and includes speaker timecodes that indicate when those speakers start and end speaking. In example implementations, as noted above, the audio frames 302 that are provided by segmenter module 301 have already been split into segments that each include a single speaker, and have been assigned time code data (e.g., start and end time codes).

In an example implementation, speaker detection and diarization inferencing module 304 is implemented using a speaker segmentation model and a speaker embedding model analysis audio characteristics of the audio data included in an audio frame 302. In such examples, speaker detection and diarization inferencing module 304 can, by way of example, perform the following operations: (1) Process respective audio frames 302 through the speaker embedding model to generate a respective speaker embedding for each audio frames; (3) Apply a clustering algorithm (for example, Density-Based Spatial Clustering of Applications with Noise, DBSCAN) to group similar speaker embeddings (and thus their associated audio frames) into clusters; (4) Compute a centroid for each subject cluster and measure a distance (e.g., a cosine distance) between each cluster and known speaker reference cluster centroids that have been previously identified; and (5) if the centroid for a subject cluster falls within a threshold distance of a known speaker reference cluster centroid, a speaker ID associated with the known speaker reference cluster centroid can be assigned to all audio frames 302 that have speaker embeddings in the subject cluster; if the centroid for the subject cluster does not fall within the threshold distance of any known speaker reference cluster centroid, a new speaker has been identified, and a new speaker ID can be assigned to all audio frames 302 that have speaker embeddings in the subject cluster, and the centroid of the subject cluster can be added to the set of known speaker reference cluster centroids together with the new speaker ID; and (6) generate diarized speaker data 306, which includes timecodes for the identified audio frames 302 and speaker IDs for such frames. Accordingly, in an example implementation, respective speaker IDs can be assigned by using a speaker embedding model to generate a speaker embedding for a subject segment of the audio data and assigning the speaker ID based on a comparison of the speaker embedding to a set of historic speaker embeddings that are associated with known speaker IDs. By way of example, unique speakers may be identified as “speaker 1, speaker 2, speaker 3, etc.”. A user may then assign name labels to speaker identities at a later editing stage (e.g., via a user editable speaker list 222 in FIG. 2, for example).

The diarized speaker data 306 and the detected language transcript data 316 form part of transcript data 322.

Referring again to FIG. 1, transcription controller 138 receives the transcript data 322 (i.e., the diarized speaker data 306 and the detected language transcript data 316) and combines the information to generate multilingual transcript 134 in format suitable for use by online collaborative editor 140. In at least some examples, transcript 134 is formatted as a mark-up text language document, for example, in a JavaScript Object Notation (JSON) or Extensible Markup Language (XML) format. The transcript 134 generated in respect of a live session can take the form of a single file or a set of linked files.

In at least some examples, the transcription controller 138 provides transcript data 322 to a text-to-text multi-language translation module 139, together with one or more other language indicators that indicate languages for which a translation of the detected language transcript data 322 is requested. By way of example, in the example, of FIG. 2, the user desires to be presented a real-time French translation of the transcribed text of media data 101B. In such an example, a French language indicator can be previously provided as input to text-to-text translation module 139, which processes the detected language transcript data 322 to generate corresponding other language (e.g., French) transcript data. In some examples, text-to-text multi-language translation module 139 includes a DNN model in the form of an attention-based text-sequence-to-text-sequence translation model. By way of non-limiting example, the above-noted OpenAI™ Whisper model from Hugging Face, Inc. can also be used to implement text-to-text multi-language translation module 139.

In example embodiments, transcript 134 can include detected language transcript data 322 together with any translations of that data. The transcript 134 is maintained by transcription controller 138 as a collaborative document that is updated as new media is received as part of a live session, and can be viewed and updated via online collaborative editor 140 during the live session by multiple parties using their respective client devices 150 (e.g., see FIG. 2).

As noted above, FIG. 2 illustrates an example of a user interface display screen 200, as presented on a browser interface display of a client device 150 that is an active session with online collaborative editor 140, showing a transcription segment 202 of a media source with a corresponding translation segment 204 that have been generated in respect of a transcript 124. In example, embodiments, online collaborative editor 140 enables the segments 202, 204 to be displayed in real-time at client device 150 as they are generated as part of transcript 124 in respect of an incoming media data 101A. Media content 126 can be simultaneously be played back (e.g., an audio component and, in the case of audio-visual media, also a video component 206) by the client device 150 in synchronization with the on-screen display of the text data. For example, the client device 150 can provide audio playback of the original media in time alignment with the progression of visual markers 224A and 224B through the detected language transcription segment 202 and its' translation segment 204, respectively. Furthermore, individual client devices 120 can each individually pause real-time playback, rewind, and replay as required.

The screen 200 shows a first paragraph in English (original language transcription segment 202), and the corresponding French language translation segment 204 as a second paragraph. Information labels 208, 210 (e.g., “ENG Live Detected”, “FR Live Transcribed) may be displayed physical proximity to the displayed text segments 202, 204 indicating: (i) if the segments are an original language transcription or a translation; (ii) language of the text segment; and (iii) if the segments are being displayed as part of a live stream.

In some examples the original language transcription segment 202 and corresponding translation segment 204 can be presented side-by-side as columns, rather than over/under as shown in FIG. 2.

As can be seen in FIG. 2, online collaborative editor 140 enables a user to use an input device to select and highlight text sections 218, 220 of displayed text segments, and will display start and end timing for the selected segments. In example embodiments, selection of text in the original language transcription segment 202 (e.g., user selection of text section 218) causes the corresponding section (e.g., text section 220) of the translated text segment 204 to also be highlighted and displayed with timing data, and vice versa. In example embodiments, speaker labels 212 are displayed in physical proximity to the displayed transcription segment 202 and translated text segment 204. In some examples, name labels can be assigned through the online collaborative editor 140 using a user edible speaker list 222 that link speaker names to uniquely identified speakers.

In example embodiments, the audio data can be played back at the client device 150 in conjunction with the text sections 218, 220, including for example in time alignment as described above. As shown in FIG. 2, online collaborative editor 140 can support a set of media playback control functions 230.

In example embodiments, online collaborative editor 140 enables users at each participating client device 150 to provide input verifying that they authenticate content of a particular displayed transcription segment 202 and its corresponding translated text segment 204. For example “verified by you” buttons 214, 216 can be selected using a user input device associated with client device 150 to enable that user to confirm that the user has verified the accuracy of the displayed transcription segment 202 and its corresponding translated text segment 204 and that the segments both accurately correspond to each other and the audio (and video if present) playback that accompanies their display. In example implementations, details of the user authentication (including a verification time stamp and verifying user ID) as received via the collaborative editor 140 from a client device 150 can be embedded as attributes (for example, as paragraph level attributes) into the transcript 134, and the verification data can be shared with other users through their respective client devices 150. In this regard, service 110 is, in example embodiments, configured to receive a message from client device 150 indicating that a portion of the transcript is verified as matching the audio playback and update the transcript 134 to indicate the verification and a verifier identity.

### EXAMPLE 1

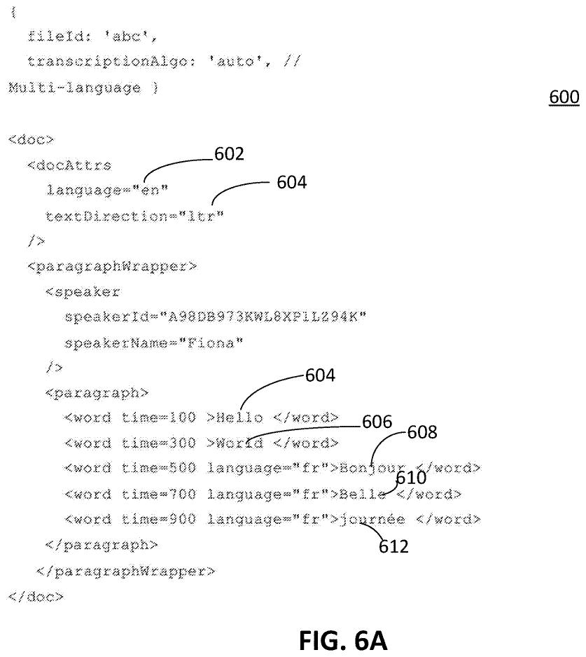

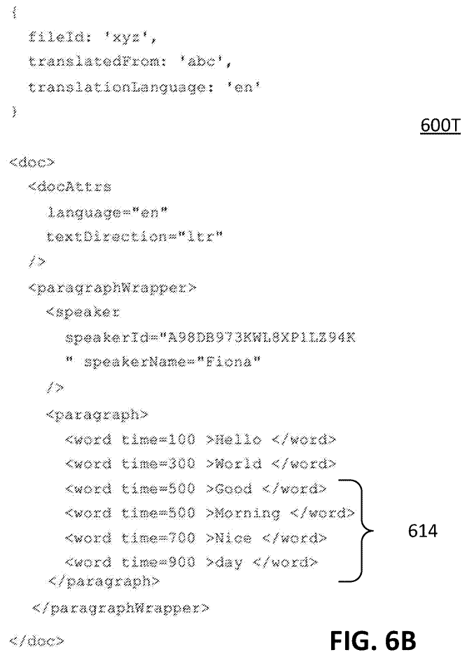

In order to facilitate a further understating of disclosed implementations, a first example of the operation of system 90 will be described in the context of words spoken by a bilingual speaker, e.g., (“Fiona”) during an interview session. In the present example, speaker Fiona is recorded saying a discrete multi-language phrase “Hello World Bonjour Belle Journee”, that is preceded and followed by a lull in speech activity. FIG. 6A shows an example of an XML snippet 600 that forms part of a transcript 134 having a File ID ‘abc’, and which corresponds to the spoken words “Hello World Bonjour Belle Journee”. In the present example, the default language for the session has been selected as “English”, which is a left-to-right language, as represented in FIG. 6 by the default document attributes <language=“en”>602 and <textDirection=“Itr” 604.

With reference to FIG. 1, in an example embodiment, a user of media capture device 100 activates an interview session. By way of example, media capture device 100 may have a client application 180 downloaded that is configured to interface through network 152 with the data ingestion module 112 of transcription, translation and collaborative editing service 110 to facilitate live audio capture and transcription. The client application 180 may include functionality that enables the user to include session metadata, for example, a session title (e.g., “Interview with Fiona”) and other information about the interview session such as the default language (e.g., “EN”).

As part of the interview session, media capture device 110 records the speaker (Fiona) saying, among other statements, “Hello World Bonjour Belle Journee” and causes media data 101A that includes the session metadata and an acoustic signal corresponding to the phase “Hello World Bonjour Belle Journee” to be transmitted to the ingestion module 112 of service 110. Ingestion module 112 recovers the transmitted media data 101A to output corresponding media data 101B in a format for processing by service 110. Media procession 114 extracts segments of audio data 131 (e.g., an acoustic signal) and corresponding media content 136.

The audio data 131 which includes, within its duration, the phase “Hello World Bonjour Belle Journee”, is passed to multi-language transcript generator 116. With reference to FIG. 3, the segmenter module 301 detects the nulls in voice activity that precede and follow the phrase, as well as the existence of two languages within the phrase, causing normalize and chunk module 300 to extract, as two discrete audio frames 302 the acoustic signal representing the phrase “Hello World” (e.g., as a first audio frame 302) and Bonjour Belle Journee”(e.g., as second audio frame 302).

Language detection module 310 receives the first and second audio frames 302 and proceeds to detect the languages represented in each the audio frames 302, and outputs a language token 312 for each audio frame 302, e.g., a language token representing “English” for “Hello World” and a language token representing “French” for “Bonjour Belle Journee”.

With reference to FIG. 3, the audio signal frames 302 and their respective language tokens 312 are provided to encoder-decoder model 402 of speech-to-text transcription module 314, which are converted to text tokens in the language corresponding to the language token 312, resulting, in the present example, in the text tokens “Hello” 604 and World“ 606 for the audio frame 302 containing “Hello World” and the text tokens “Bonjour” 608, “Belle” 610 and “Journee” 612 of the frames 302 containing “Bonjour Belle Journee”. Time-code estimator operation 406 collaborates with encoder-decoder model 402 to estimate time code data 408 for each respective text token. In the illustrated example, the time code data is shown as index values (e.g., “word time=100” in the case of text token “Hello” 604) that map to a location of the text token in the audio data 131.

The text tokens 404 and their associated time codes 408 generated by speech-to-text transcription module 314, together with a language indicator for each word (e.g., language token) are collectively represented in the detected language and transcript data 316, which corresponds to the audio signal represented in the input audio frame 302.

With reference to FIG. 3, each audio frame 302 is provided to speaker detection and diarization inferencing module 304. In the present example, the speaker is identified (e.g., “Speaker ID=”A98DB973KWL8XP1LZ94K”) for the audio frame 302 and output with respective timecode for the audio frame 302 as speaker data 306.

Detected language transcript data 316 and Speaker Data 306 are combined to provide transcript data 322 that corresponds to audio frame 302.

Referring to FIG. 1, transcription controller 138 receives transcript data 322 and appends such data as it is received during the live interview session of the present example into transcript 134, as represented by XML snippet 600 of FIG. 6A. In the example of FIG. 6A, the speaker Name “Fiona” has been previously assigned to Speaker ID=“A98DB973KWL8XP1LZ94K”, and thus is reflected in the XML snippet 600 as in a paragraph wrapper that corresponds to audio frame 302. As shown in FIG. 6, any words that are not in the default language (English) are each associated with a with a respective language attribute tag (e.g., “fr”).

In the illustrated example, transcription controller 138 is configured to automatically obtain translations for parts of the transcript data 322 that are not in the default language. For example, the detected language transcript data 322 (or at least the non-default language words therein) are provided to text-to-text translation module 139 together with an indication of the default language and the original detected language that is to be translated. Text-to-text translation module 139 returns the desired translation, which is added to the transcript 134. In one example, transcript 134 includes a multi-language detected language transcript file (as represented by snippet 600 of FIG. 6A) with a corresponding unilingual transcript file, an example of which is represented by snippet 600T of FIG. 6B. As shown in FIG. 6B, the unilingual file includes a link “{translated From: ‘abc’}” indicating the source file it was obtained from, as well as an indication of the language of the unilingual transcript. In snippet 600T, the French language text tokens “Bonjour” 608, “Belle” 610 and “Journee” 612 have been replaced with their respective translations. In the illustrated example, where a translation of a single text token “Bonjour” includes two words “Good” and “Morning”, both words are attributed the same timing index (e.g., time index 500) as the original language word “Bonjour”.

### EXAMPLE 2

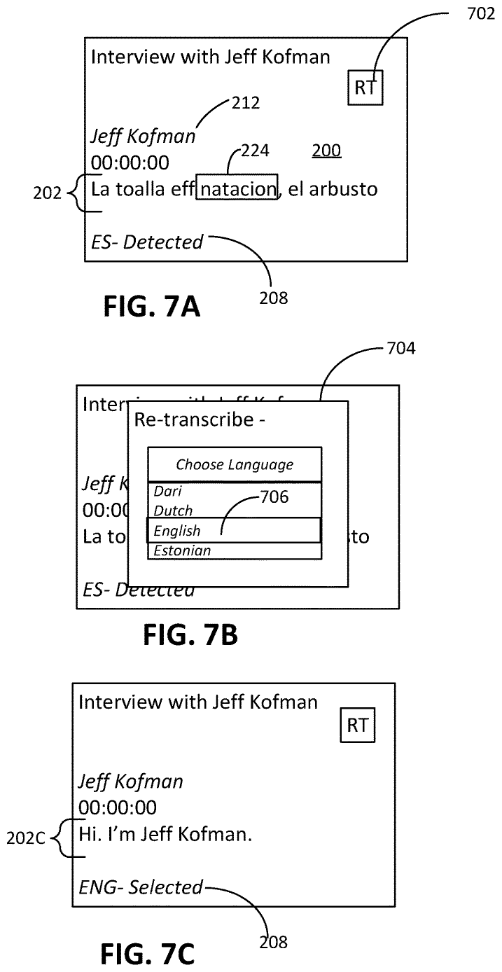

A second example will be described in the context of correcting an improper translation. FIGS. 7A, 7B and 7C show successive examples of information that may be displayed on a display screen 200 on a screen of a client device 150 in an example scenario where the language detection module 310 has generated an incorrect language token 312. In FIG. 7A, the displayed transcription segment 202 is incorrect as a result of an audio frame 302 being incorrectly classified by language detection module 310 as being in the Spanish language (information label 208 indicates “ES-Detected”). The client device 150 provides audio playback of the original media in time alignment with the progression of a visual marker 224 through the transcription segment 202. In the illustrated use case, a user recognizes that the displayed transcription segment 202 and information label 208 do not match the language of the media that is being played back. In such as case, the user can use a user input device to select a user interface component, for example a button 702, to request a re-transcription of the transcription segment 202 that is being played back. In some examples, a user can use a select one or more segments for re-transcription.

As shown in FIG. 7B, in response to user selection of button 602, online collaborative editor 140 client device 150 provides a dialog box 704 that includes a drop-down list of user selectable items that correspond to languages that are supported by the language detection and transcription model 303. In response to user selection of the correct language (e.g., English, indicated by onscreen selection marker 706), the online collaborative editor 140 interacts via transcription controller 138 with the multilanguage transcript generator 116 to provide a corrected language token 312C. The transcription controller 138 interfaces with multi-language transcript generator 116 to obtain a corrected transcription for the audio frame(s) 302 that correspond to the identified text segment(s) 202, updates the transcript 134 accordingly, and provides the inline collaborative editor with access to the updated transcript 134. In the event that a translation is also being displayed, a corrected translation will also be obtained by the transcription controller 138 from text-to-text-translation module 139 for the impacted segments and incorporated into the updated transcript 134.

FIG. 7C illustrates the display of a corrected language segment 202C.

### EXAMPLE 3

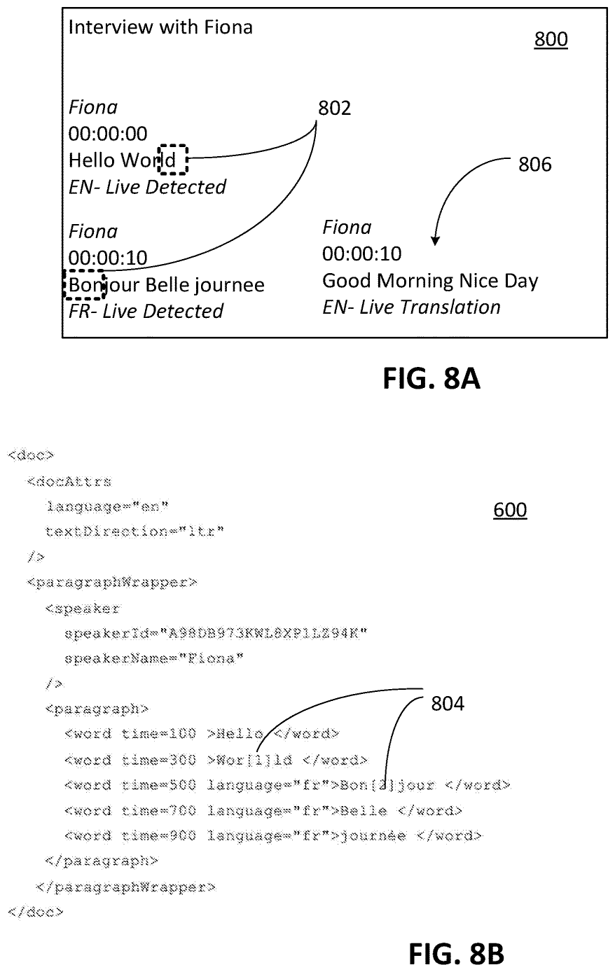

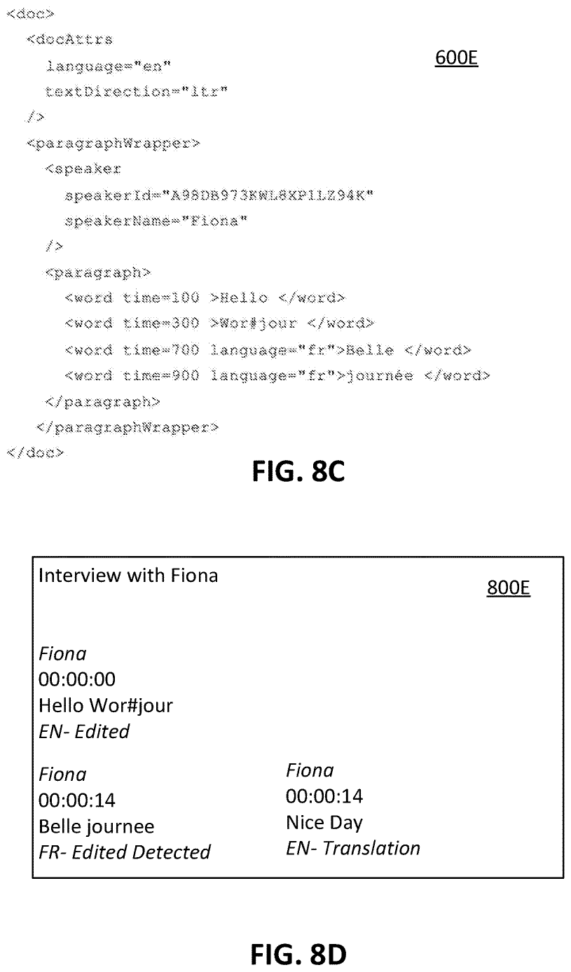

With reference to FIGS. 8A, 8B, 8C and 8D, an example of editing the snippet 600 of FIG. 6A will now be described. FIG. 8A illustrates an example of a user interface display screen 800, as presented on a browser interface display of a client device 150 that is an active session with online collaborative editor 140, showing a display of a transcription segment that corresponds to the snippets 600 and 600T of Example 1 described above. In the illustrated example, the English translation 806 of the detected language French words are displayed in a region of the user interface display 800 that is adjacent to the detected French words. In the illustrated example, a user operates a user input device to select the displayed text “Id Bon” that spans English and French portions of the displayed text. By way of example, an on-screen selection marker 802 can provide visual feedback of the user selection. Selection of the text is represented in the XML snippet 600 as extend from the number [1] to number [2], indicated by reference 804. In the illustrated example, the user enters a new character (e.g., the character “#”) while the text “Id Bon” is selected. Based on such user input, online collaborative editor 140 causes the text “Id Bon” to be replaced with “#”, resulting in the ‘word’ “Wor #jour”, and updates the transcript 134 and user interface delay accordingly.

FIG. 8C illustrates the resulting edited XML snippet 600E from transcript 134 and FIG. 8D illustrates the updated user interface screen 800E. As can be seen in FIG. 8C, the starting time code for the updated word “Wor #jour” (Index “300”) is set to the starting time code of the original first word “world” (i.e., the left-most word) in the selected text. The translated XML snippet 600T is also updated to reflect the edit, as reflected in updated user interface screen 800E represented in FIG. 8D.

In at least some examples, the edit is reflected in real-time across any other client devices 150 that are displaying the subject XML snippet.

### EXAMPLE 4

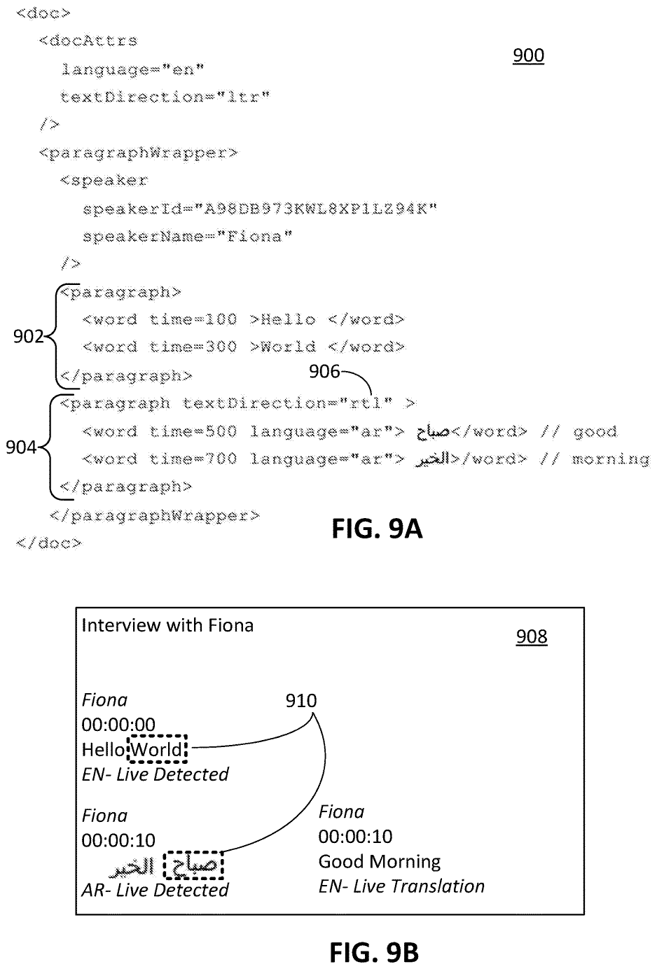

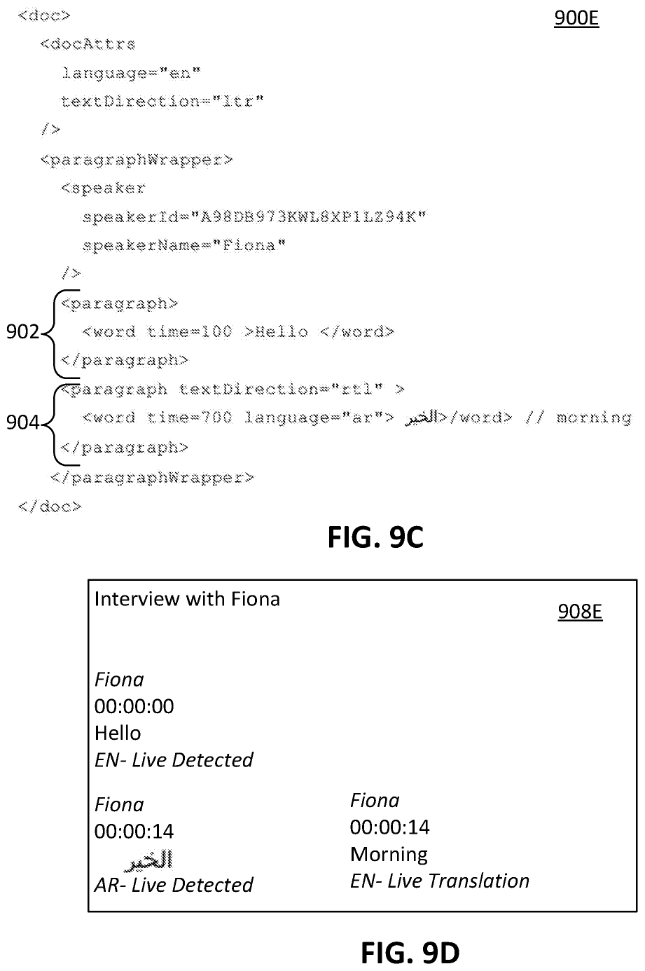

A further example will now be disclosed, illustrating editing of text transcript that includes mixed left-to-right and right-to-left language segments. In this regard, FIG. 9A shows an example of a further XML snippet 900 that forms part of a transcript 900. FIG. 9B illustrates an example of a user interface display screen 908, as presented on a browser interface display of a client device 150 that is an active session with online collaborative editor 140, showing a display of a transcription segment that corresponds to the snippet 900. In a manner similar to described above in respect of Example 1, Snippet 900 has been generated by Transcription, Translation and Collaborative Editing Service 110 in respect of a words spoken by a bilingual speaker, e.g., (“Fiona”) during an interview session. In the present example, speaker Fiona is recorded saying a discrete multi-language phrase including “Hello World” in English and “Good Morning” in Arabic. In the present example, the default language for the session has been selected as “English”, which is a left-to-right language, as represented in FIG. 9A by the default document attributes <language=“en”> and <textDirection=“Itr”. The non-English words included in snippet 900 include word-level attributes that indicate their language (e.g.“ar”). Additionally, as Arabic is a right-to-left language, and thus does not conform to the default document language text direction, the snippet 900 includes the language text direction attribute <textDirection “rtl”> associated with the Arabic words. In the particular example, transcription controller 138 organizes adjacent text segments that have different text directions into separate XML paragraphs 902, 904, and marks paragraph(s) 904 that contain text words having the non-default text direction with an appropriate text direction attribute 906 (e.g., <textDirection “rtl”>). When displaying “rtl” paragraphs, online collaborative editor 140 displays such paragraphs using right-to-left text direction, as shown in FIG. 9B. The corresponding English translation (obtained from text-to-text translation module 139) is provided by is shown in “Itr” text direction.

In the illustrated example, a user interacts with a user input device to select the displayed text “World” and the Arabic “Good” that spans English and Aribic portions of the displayed text. In the illustrated example, online collaborative editor 140 causes on-screen selection marker 910 to provide visual feedback of the user selection in accordance with the “Itr” and “rtl” text directions in the respective English and Arabic portions of the displayed text.

In the illustrated example, the user enters a “backspace” character while the text “World” and Arabic “Good” are selected. Based on such user input, online collaborative editor 140 causes the selected text to be deleted, updates the transcript 134 and user interface display in accordance with the default text direction “Itr” for English words and “rtl” for the Aribic words. FIG. 9C illustrates the resulting edited XML snippet 900E from transcript 134 and FIG. 9D shows the updated user interface screen 908E.

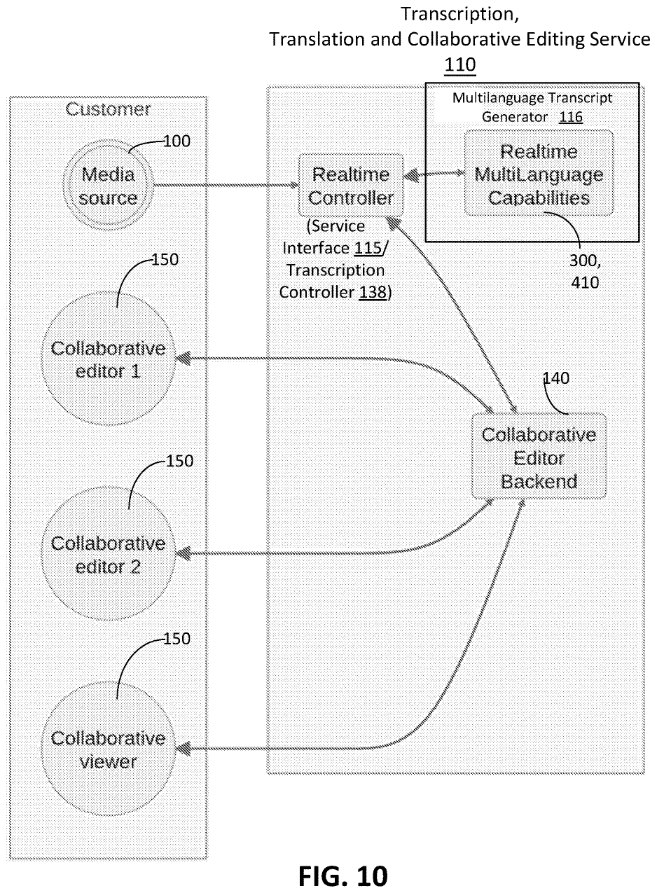

FIG. 10 illustrates a further block diagram representation of aspects of system 90, according to further example implementations. Back-end services (e.g., Transcription, Translation and Collaborative Editing Service 110) provide language detection, transcription and speaker detection, and diarization of incoming media that contains multiple languages. Following transcription, a new multi-language capable document (e.g., transcript 134) includes embedded schema and allows collaborators to view and edit the entire document as it is being produced, with each collaborator able to independently interact with any part of the document without impacting other collaborators or the in-progress realtime transcription.

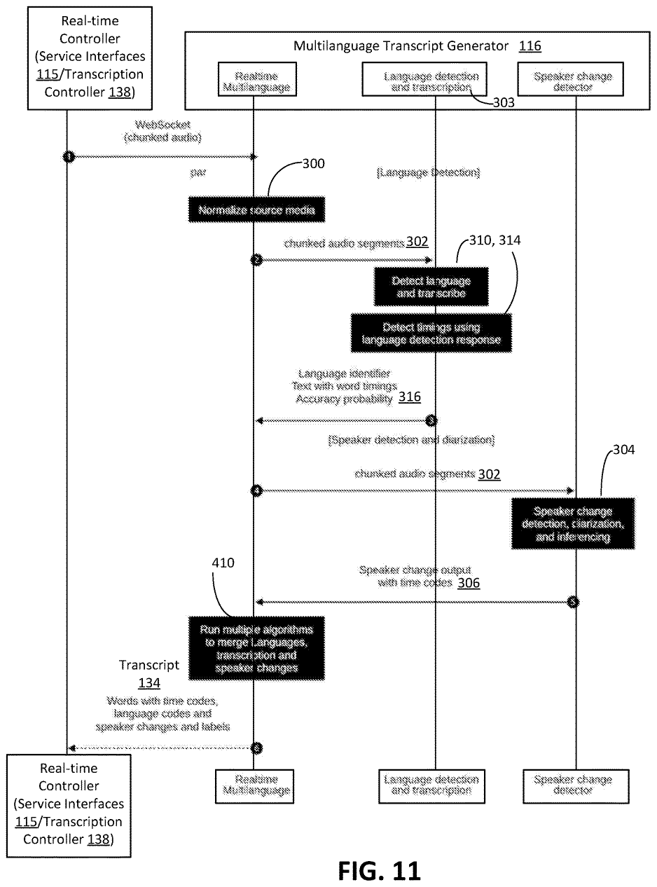

FIG. 11 is a further diagram illustrating the functional components of the multi-language generator module 116 of service 110 and sequence details illustrating how the components support multi-language detection and transcription, according to further example implementations.

In example embodiments, an incoming acoustic signal is split into audio frames 302 (e.g., by normalize and chunk module 300). Frames can, in some examples be discrete, non-overlapping and of varying length that are split based on detected lulls by segmenter 301. In other examples, voice activity detector 302 may be omitted and frames 302 can be overlapping and have fixed durations. By way of non-limiting examples such frames could be 5 s long frames with a 50% overlap.

Each audio frame 302 is sent to the language detection and transcription module 303. The language detection and transcription module 303 can, for example, be implemented using one or more transformer-based encoder-decoder models, for example the Huggingface transformer implementation of the OpenAI model Whisper. Language detection and transcription module 303 returns the transcription together with the detected language and timecodes that mark the beginning and, in some examples, end of each word (detected language transcript data 316). This information is used to assemble a complete transcript 134.

In the example scenario where overlapping constant length audio frames 302 have been used to generate transcript data, language detection and transcription module 303 can apply two algorithms to deal with: (i) Potentially cropped words; and (ii) Repeated words, as described below.

### (i) Removing Potentially Cropped Words

Since the split into frames is done with a fixed window length it is possible that the audio at the beginning or at the end of the frame contains only a portion of the spoken words. A margin (seconds) is used to trim the chunk words at the start and end to reduce the chance of incomplete words. One possible example of such a margin is 0.625 s.

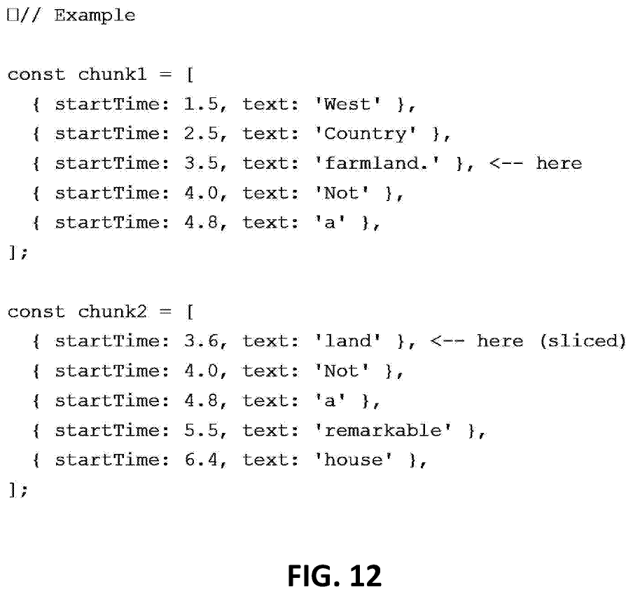

FIG. 12 shows an example where chunk2 starts with the word “land.” This appears to have been clipped. It can be see form FIG. 12 that this text was transcribed correctly in chunk1 as farmland. To mitigate this scenario, the text at the start and end of a chunk is cropped using a defined margin.

### (ii) Dealing With Repeated Words

Using overlapping frames induces the possibility that a word can be transcribed multiple times if it is present in consecutive frames. The word timecodes are used to identify overlapping words. Some tolerance is required because the timecodes estimation can be slightly different in consecutive frames. The parameter tolerance (seconds) is used to find the point of merge, when merging two arrays of words with time. The tolerance is how far apart word times can be at the join.

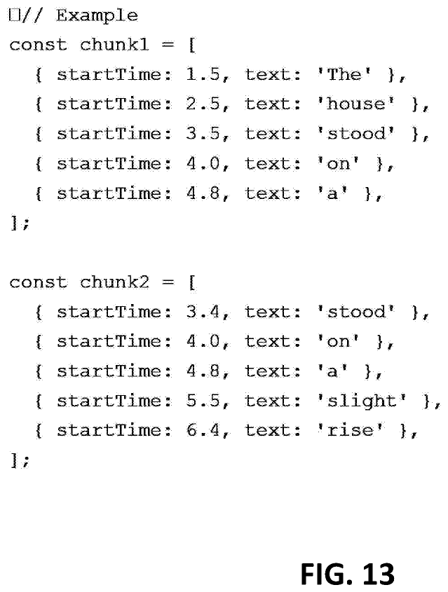

FIG. 13 shows an example where chunk1 and chunk2 should merge at the word “stood” or “on”. In this example “stood” is 0.1 second out. This would mean that this would only join if the tolerance was 0.11 or greater.

### Detecting Timecodes From Encoder-Decoder Predictions

A transformer based encoder-decoder model such as Whisper may not provide timecodes with transcription. In example embodiments, one way of estimating the timecodes is to look at the cross-attention layer. Given a snippet of audio, a timecode estimation algorithm of the service works as follows:
1. It gets the transcription using the encoder-decoder model and splits it into words;
2. It gets the cross-attention layers from the model;
3. Aggregate the cross-attentions by adding them together and obtaining a 2-D matrix. This matrix will have as many rows as decoded tokens and as many columns as input feature frames (e.g., as illustrated in FIG. 5);
4. For each detected token, indexed with/:
   a. Check if the token is the beginning of a word (sometimes long words can be split in multiple tokens so when looking for the beginning of the word we want to get the beginning token);
   b. Find the argmax of the i-th row of the aggregated cross-attention matrix;
   c. Convert the index to seconds and save it as the beginning of the word and the end of the previous word (if it's not the first word; if it's the last word of the transcription set the end of the word time to the end of the audio snippet)

### Speaker Change Detection and Diarization

In order to break the transcription into paragraphs we need to identify the moment when the speaker changes in the audio. A speaker change algorithm is applied that works with the same input of the language detector and transcriber.

In some examples, speaker change detection may be implemented using the pyannote.audio segmentation inference model, which may, for example, detect the presence of up to 3 speakers in the audio. It takes an audio signal as input, splits it into frames and returns for each frame the probability of the presence of each speaker in the audio.

In some examples, a speaker change algorithm can work as follows:
1. Run the audio through the segmentation inference
2. Assign every probability lower than a threshold (at the moment 0.1 but we might want to play with it in the future) to 0.0
3. Return
   a. If the probability are all equal to 0.0→No speakers
   b. If (more than 1 speaker has probability>0.0) and (the speaker with the highest probability in the first 50 frames not equal to the speaker with the highest probability in the last 50 frames)→Speaker change
   c. Else→No change
4. If a speaker change has been detected the speaker change time is identified with the first frame where the probability speaker with the highest probability in the first 50 frames is equal to 0.0

### Schemas

In examples, transcript 134 uses a document schema that captures all the characteristics and the features that enable collaborative editor 140 to function as required. This schema includes attributes relating to the transcribed text as well as attributes required to perform actions related to translation, presentation and playback of the transcript into other languages.

The schema (for example as illustrated in XML snippets of the present disclosure) includes entities, some of which represent words. These entities have been extended to support language related attributes, including, for example, the transcribed language. Further supported attributes can include probability of accuracy, a structured representation of lower probability detection, and whether the transcribed entity is an intermediate inferencing result or a final result.

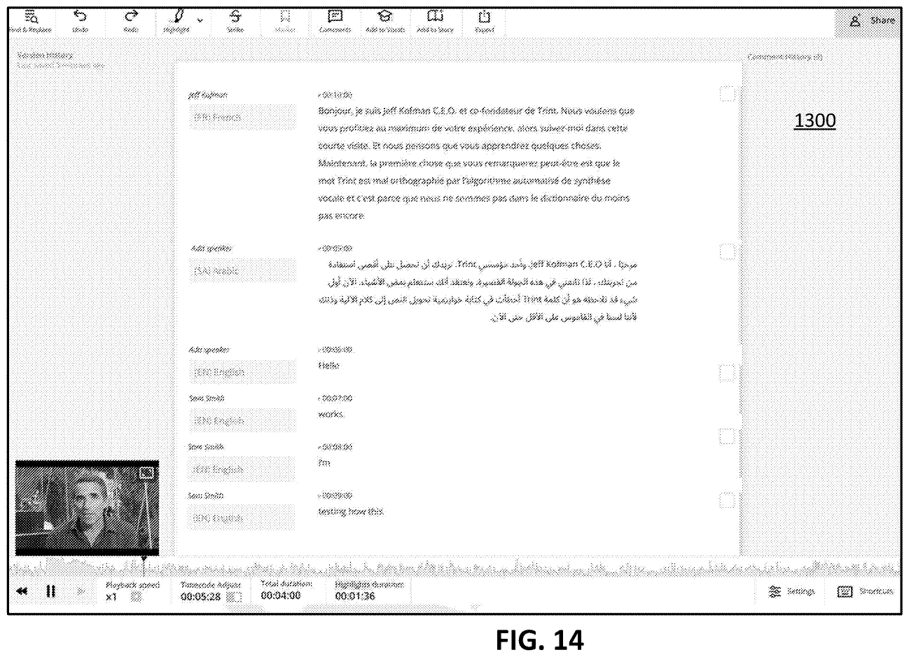

FIG. 14 illustrates an example of a user interface screen 1300, as presented on a browser interface display of a client device 150, showing a transcript of media source demonstrating some of the complexities to be tackled, such as handling of Left To Right (LTR) and Right To Left (RTL) languages at the paragraph level as well as within each paragraph. The handling of such complexities are described in Example 4 above.

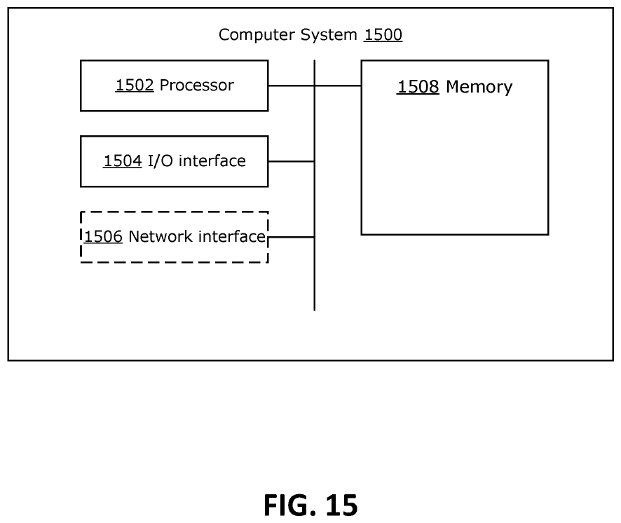

FIG. 15 illustrates an example of a computer system 1500 that can be used to implement one or more of the modules, services, or devices described herein. Computer system 1510 includes one or more processors 1502, such as a central processing unit, a general processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 1502 may collectively be referred to as a “processor device”. The computer system 1510 also includes one or more input/output (I/O) interfaces 1504, which interfaces with input devices (e.g., microphone, touch screen, mouse, keyboard) and output devices (e.g., speaker, display).

The computer system 1510 can include one or more network interfaces 1506 that may, for example, enable the computer system 1510 to communicate with one or more further devices through a communications network such as a local area wireless network.

The computer system 1510 includes one or more memories 1508, which may include a volatile or non-volatile memory (e.g., a flash memory, a random access memory (RAM), and/or a read-only memory (ROM)). The non-transitory memory(ies) 1508 may store instructions for execution by the processor(s) 1502, such as to carry out examples described in the present disclosure. The memory(ies) 1508 may include other software instructions, such as for implementing an operating system and other applications/functions.

In some examples, the computer system 1500 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the computer system 610) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computer system 610 may communicate with each other via a bus, for example.

Although the present disclosure describes methods and processes with steps in a certain order, one or more steps of the methods and processes may be omitted or altered as appropriate. One or more steps may take place in an order other than that in which they are described, as appropriate.

As used herein, statements that a second item (e.g., a signal, value, scalar, vector, matrix, calculation, or bit sequence) is “based on” a first item can mean that characteristics of the second item are affected or determined at least in part by characteristics of the first item. The first item can be considered an input to an operation or calculation, or a series of operations or calculations that produces the second item as an output that is not independent from the first item.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The features and aspects presented in this disclosure may be embodied in many different forms and should not be construed as limited to the embodiments set forth herein. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The contents of all published documents identified in this disclosure are incorporated herein by reference.

1. A computer implemented method of processing multi-language audio data that includes at least (i) a first audio segment that represents a first group of one or more spoken words that correspond to a first language, and (ii) a second audio segment that represents a second group of one or more spoken words that corresponds to a second language, the method comprising:
automatically generating first transcript data for the first audio segment, the first transcript data including text representations of the first group of one or more spoken words, and timecode data mapping the text representations to respective times within the multi-language audio data;
automatically generating second transcript data for the second audio segment, the second transcript data including text representations of the second group of one or more spoken words, and timecode data mapping the text representations to respective times within the multi-language audio data;
combining the first transcript data and the second transcript data into a transcript document; and
enabling access to the transcript document and the multi-language audio data to a client device for viewing of the transcript document in conjunction with audio playback of the multi-language audio data.

2. The method of claim 1 comprising receiving from the client device an indication that at least one of the first transcript data and the second transcript data is verified as matching the audio playback and updating the transcript document to indicate the verification and a verifier identity.

3. The method of claim 1 wherein enabling access to the transcript document and the multi-language audio data is performed in respect of a plurality of client devices such that the transcript document can be viewed in conjunction with the audio playback of words at the plurality client devices.

4. The method of claim 1 comprising automatically generating a third transcript data that includes a translation of the text representations in the second audio segment into translated text representations corresponding to a selected language, and combining the third transcript data into the transcript data to enable the text representations in the third transcript data and the second transcript data to be viewed simultaneously at the client device.

5. The method of claim 4 wherein the selected language is the first language, and the translated text representations are each associated with timecodes mapping the translated text representations to respective timecodes corresponding to the spoken words from which they were translated.

6. The method of claim 1 comprising:
automatically assigning respective speaker IDs to the first audio segment and the second audio segment based on analysis of audio characteristics the multi-language audio data; and
associating the assigned speaker ID's with the first transcript data and the second transcript data in the transcript document, enabling the speaker ID's to be viewed at the client device.

7. The method of claim 6 wherein automatically assigning the respective speaker IDs comprises using a speaker embedding model to generate a speaker embedding for a subject segment of the audio data and assigning the speaker ID based on a comparison of the speaker embedding to a set of historic speaker embeddings that are associated with known speaker IDs.

8. The method of claim 1 wherein:
automatically generating the first transcript data for the first audio segment comprises:
detecting that the first group of one or more spoken words of the first audio segment correspond to the first language and generating a first language token for the first audio segment that indicates the first language;
providing the first audio segment and the first language token as inputs to a transformer-based encoder-decoder model to generate a first group of one or more text tokens for the first group of spoken words;
generating, for the first group of one or more text tokens, respective timecodes based on information received from a cross-attention mechanism of the transformer-based encoder-decoder model; and
combining the first group one or more text tokens and the respective timecodes to provide the first transcript data; and
automatically generating the second transcript data for the second audio segment comprises:
detecting that the second group of one or more spoken words of the second audio segment correspond to the second language and generating a second language token for the second audio segment that indicates the second language;
providing the second audio segment and the second language token as inputs to the transformer-based encoder-decoder model to generate a second group of one or more text tokens for the second group of spoken words;
generating, for the second group of one or more text tokens, respective timecodes based on information received from a cross-attention mechanism of the transformer-based encoder-decoder model; and
combining the second group one or more text tokens and the respective timecodes to provide the second transcript data.

9. The method of claim 1 comprising segmenting the multi-language audio data into the first audio segment and the second audio segment by detecting a discrete segment of continuous voice activity and the segmenting the discrete segment of continuous voice activity based on one or both of languages and speakers represented therein.

10. The method of claim 1 comprising:
receiving media data that includes the multi-language audio data;
extracting audio frames from the media data that each correspond to a respective segment of continuous voice activity from a single speaker in a single language.

11. The method of claim 10 wherein the media data is received through a communication network from a media capture device as part of a live recording session.

12. The method of claim 1 wherein the method is performed as a cloud-based service.

13. The method of claim 1 comprising:
receiving an indication from the client device that the second transcript data does not correspond to the second language;
automatically regenerating second transcript data such that the text representations of the second group of one or more spoken words corresponds to the second language; and
updating the transcript document with the regenerated second transcript data.

14. The method of claim 1 wherein the transcript document includes markup language that includes text representations as text elements and attribute elements that indicate a language of the text elements, speaker ID attributes, language attributes and timecode attributes.

15. The method of claim 1 wherein the first language corresponds to a left-to-right text direction language and the second language corresponds to a right-to-left text direction language.

16. A server device comprising:
a processor; and
a memory storing instructions which, when executed by the processor, cause the server device to perform the method of claim 1.

17. An apparatus comprising a processor configured to cause the apparatus to perform the method of claim 1.

18. A non-transitory computer readable medium having machine-executable instructions stored thereon, wherein the instructions, when executed by a processing unit of an apparatus, cause the apparatus to perform the method of claim 1.

19. (canceled)

20. (canceled)

21. The method of claim 2 comprising:
in the event that the at least one of the first transcript data and the second transcript data has been verified as matching the audio playback and the transcript document updated to indicate the verification and verifier identity, cause the at least one of the first transcript data and the second transcript data to be displayed by a further client device in conjunction with visual indicators indicating the verification and verifier identity.

22. The method of claim 9 wherein detecting the discrete segment of continuous voice activity comprises detecting a null between periods of successive voice activity.
